(19) United States
(12) Patent Application Publication
(10) Pub. No.: US 2011/0107871 A1
(43) Pub. Date: May 12, 2011

(54) RELEASE MECHANISM FOR A SHEET WINDLASS HANDLE

(76) Inventors: Frode Andersen, Vejle (DK); Annette Andersen-lau, Vejle (DK)

(21) Appl. No.: 12/735,204

(22) PCT Filed: Dec. 18, 2008
(86) PCT No.: PCT/DK2008/050319

§ 371 Date: Dec. 8, 2010

(30) Foreign Application Priority Data
Dec. 21, 2007 (DK) PA 2007 01874

(51) Int. Cl. G05G 1/10; G05G 1/12

(52) U.S. Cl. 74/545

(57) ABSTRACT

A handle (1) for a sheet windlass, where the handle is of the type having a first part (2) adapted for engaging the windlass, a torque transmitting part arranged largely perpendicularly to an axis of symmetry (4) of the first part (2) and a grip arranged with its longitudinal axis in parallel with the axis of symmetry (4) of the first part (2), where a releasable locking means is arranged in the first part (2), the locking means adapted to retain the handle in engagement with the sheet windlass, wherein the first part (2) has a hole (13) in a central part arranged coaxially with the axis of symmetry (4), and that an L-shaped locking member (10) is provided in the hole (13).

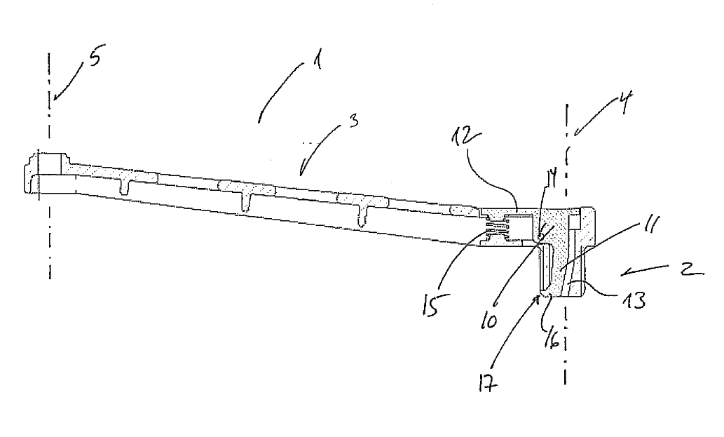

### FIELD OF THE INVENTION

The present invention concerns a windlass handle of the type typically used on sailboats for inserting into a sheet windlass.

### BACKGROUND OF THE INVENTION

The handles are typically provided with a cylindric first part where a number of grooves are provided along the cylinder periphery, such that the first part will be provided with a largely star-shaped cross-section, typically with four or eight star points. A hole is provided centrally of the first part. Perpendicularly to the longitudinal axis of the cylinder there is fastened one end of a torque transmitting part. At the other end of the torque transmitting part and in parallel with the cylinder axis of the first part, a handle or grip is provided rotatably about a coaxial axis. By inserting the first part in a corresponding hollow in the top of a windlass such that the grooves engage corresponding grooves in the windlass, by manually turning the handle one may transmit the moment via the torque transmitting part to the sheet windlass, thereby actuating the windlass into rotation. Often there will be appreciable forces in the sheets such that the force required to rotate the sheet windlass is reduced by the torque transmitting part, cf. the general mechanical laws regarding force times arm.

Windlass handles of this type are typically provided with a lock such that a shaft is provided through the hole on the first part. In the part of the shaft projecting up above the torque transmitting part there is provided a handle, and at the opposite end, which extends slightly above the first part, is provided a locking plate. Typically, the locking plate is square such that by turning the shaft, the corners of the locking plate may register with one of the grooves at the outer side of the first part such that the locking plate does not obstruct insertion of the windlass handle. Besides, a spring is provided, urging the locking arrangement to be at a certain position, namely a position where the corners of the locking plate do not register with the grooves on the first part. When the windlass handle is inserted in the sheet windlass, the locking plate will rotate, thereby registering with the grooves arranged inside the hole in the sheet windlass such that it will not be possible to remove the windlass handle from of the sheet windlass. When it is desired to remove the windlass handle, the small handle at the top of the shaft is turned, whereby the locking plate is rotated such that the corners of the locking plate again register with the grooves on the windlass handle, after which the handle can be removed from the sheet windlass.

A great disadvantage of this type of windlass handle is the fact that usually two hands are to be used for inserting the windlass handle. One hand is for holding the handle and the other hand is for turning the locking mechanism such that the locking plate is set in the position where the corners of the locking plate can register with the grooves in the first part, thereby enabling insertion of the windlass handle. During sailing, it may often be desirable to have a hand free for pulling the sheets while simultaneously inserting the windlass handle. This is made difficult by windlass handles of the above described type which can only be operated with two hands.

A further disadvantage of this type of handle with such a locking mechanism is that by inserting the handle in the sheet windlass, at the same time you have to manipulate the small handle turning the locking plate such that the handle can be inserted in the hollow at the top of the sheet windlass. Correspondingly, when the handle is to be released, the small handle and thereby the locking plate are to be manipulated in order to release the locking plate from the groove in the hollow.

The prior art in the form of EP 1 582 297 discloses a system wherein two locking pawls are arranged at the bottom of the first part such that a spring-biased shaft can be brought into a condition where the locking pawls are released. In the normal condition, the spring action entails that the pawls may be slid into the first part, whereby the first part is allowed to pass down into the windlass, and then to be pushed out when the first part reaches the bottom of the hole in the sheet windlass where there is formed a cutout such that the locking pawls can engage a cutout of the sheet windlass, hence making it is impossible to remove the windlass handle.

This system is rather intricate mechanically, and in practice it has appeared that the locking pawls and the release shaft over time have tend to get stuck due to corrosion products, salt, dirt and other foreign bodies that come in contact with the mechanism. In that connection it is important to note that equipment of this type is usually stored and used in a very aggressive environment, namely at sea immediately above the sea surface, and it will often be exposed to direct action of salt water and large temperature variations in connection with strong sunshine followed by cooling by water spray, and by pieces of cordage, clothes, sails and the like. It is thus a very aggressive environment that these items are to operate in, as well as it is expected that they have a very long service life with a minimum of maintenance.

### OBJECT OF THE INVENTION

It is thus an object of the present invention to provide a handle for a sheet windlass which immediately, i.e. without manipulation of a locking mechanism, can be inserted in a sheet windlass and be automatically locked in a groove provided at the bottom of the hole in the windlass, as well as it may be possible to release the mechanism with one hand only such that the windlass handle can be removed again. Moreover, it is intended to limit the number of mechanical components such that the construction is made as simple as possible and thereby as reliable as possible, whereby the actions by the very aggressive environment as described above will have the least possible influence on the function of the windlass handle.

### DESCRIPTION OF THE INVENTION

This is provided by a handle for the sheet windlass, where the handle is of the type having a first part adapted for engaging the windlass, a torque transmitting part arranged largely perpendicularly to an axis of symmetry of the first part and a grip arranged with its longitudinal axis in parallel with the axis of symmetry of the first part, where a releasable locking means is arranged in the first part, the locking means adapted to retain the handle in engagement with the sheet windlass, characterised in that the first part is a hole in a central part arranged coaxially with the axis of symmetry, and that an L-shaped locking member is provided in the hole, the locking member pivotably fitted in an upper part of the first part such that one leg of the L is arranged in the hole and the other leg of the L is arranged in parallel with the torque transmitting part, and that means are provided for urging the L-shaped locking member into a locking position where the end of the L-shaped locking member arranged in the hole in the first part has a projecting part extending beyond the geometry of the first part opposite the end of the first part where the torque transmitting part is fastened.

The relatively simple design with an L-shaped locking member which at one end of the L has a projecting part that may engage a groove provided in the sheet windlass, and which in the normal condition extends beyond the geometry of the first part, is a very stable and simple construction which in a very certain way ensures that the windlass handle is secured to the sheet windlass.

Therefore, the invention differs in principle from the prior art handles in that release of the locking mechanism is effected by a pushbutton principle, and not by turning a small release handle.

The other end of the L-shaped member is relatively simple to operate with one hand as it may be depressed whereby the L-shaped locking member rotates about pivot provided in connection with the first part such that it is ensured that the projecting part of the first leg of the L is withdrawn from the groove in the sheet windlass, after which the windlass handle can be removed. By furthermore providing means for urging the L-shaped locking member into the locking position, where the means e.g. can be a spring, foam block or other means, it is ensured that the L-shaped locking member may click into the groove by insertion, whereby the user is provided a clear perception that proper engagement between windlass handle and windlass has been provided. This engagement is simply released just by depressing the other leg of the L-shaped locking member such the first leg of the L-shaped locking member with the projecting part is moved out of the groove in the sheet windlass, whereby the handle can be removed.

In a further preferred embodiment, the leg of the L arranged in parallel with the torque transmitting part is arranged in a cutout in the latter. This enables that the windlass handle by normal use appears with a largely plane top side, or a top side where only a limited part of the L-shaped locking member protrude, such that the locking member does not interfere or get in contact with other objects on the boat, something which otherwise may give rise to adverse situations. By lowering the operating parts into the torque transmitting part of the windlass handle, it is ensured that the L-shaped member will not get caught by e.g. sheets, clothes or other objects which may prevent optimal operation of the windlass handle, and the windlass handle may also have an appearance similar to other windlass handles.

In a further embodiment of the invention, the projecting part of the leg of the L arranged in the hole in the first part is provided with a bevelling such that when the first part is inserted in the windlass, the projecting part is pressed towards the centre against the means for urging the L-shaped locking member into the locking position. Hereby it is ensured that it is not necessary to actuate the other part of the L-shaped locking member in order to ensure that the projecting part does not extend beyond the geometry of the first part, but possible to press the first part down into the corresponding cutout in the sheet windlass right away. In connection with the contact of the first part with the upper edge on the sheet windlass, the bevelled edge will slide on the upper edge of the windlass and simultaneously urge the L-shaped locking member to pivot away from its locking position, whereby the projecting part of the L-shaped locking member is pressed inside the outer geometry of the first part, whereby the windlass handle is allowed to be mounted in the sheet windlass.

The windlass handle may of course be made of usual materials, as e.g. cast aluminium, plastic and the like.

As the first part moreover has an outer geometry with grooves corresponding to largely all the sheet windlasses used commercially on pleasure boats, the windlass handle may immediately be applied independently of the design of the windlass producer.

### DESCRIPTION OF THE DRAWING

The invention will now be explained with reference to the only FIGURE of the accompanying drawing showing a cross-section of an embodiment of the invention.

The handle 1 for the sheet windlass has a first part 2 adapted for engaging the windlass itself (not shown). The first part 2 is connected with a torque transmitting part 3 which typically will be arranged largely perpendicularly to the axis of symmetry of the first part 2 indicated by reference number 4. At the opposite end of the torque transmitting part, i.e. opposite the first part, a hand grip is typically provided about an axis 5 in parallel with the axis of symmetry 4 of the first part.

In the FIGURE, no hand grip is shown; in practice, the handle may employ many different designs, however, typically there is to be a central journal arranged coaxially with the axis of symmetry 5 around which a rotatable grip is mounted, such that when the handle 1 is inserted in the windlass, by rotating the handle by manually turning the grip around the axis of symmetry 4 of the first part it is possible to actuate the windlass for pulling in and winding sheets or other cordage. The torque transmitting part of the handle 1 serves to reduce the force required to actuate the sheet windlass as well as the windlass typically is designed with gearing such that the force required to draw in e.g. a sheet is substantially reduced.

In the first part there is provided a releasable locking device 10 which is configured as an L by the arms 11, 12. The locking member 10 is provided in a hole 13 arranged in the first part 2. Besides, the L-shaped locking member 10 is arranged such that it may partially rotate about an axis 14 so that the arm 11 of the locking member can be moved back and forth in the hole 13. In order to actuate the L-shaped locking member 10 to assume a certain position in a non-actuated condition, there is furthermore provided a spring 15 actuating the arm 12 on the L-shaped locking member 10.

At the bottom of the arm 11 of the L-shaped member 10, a locking projection 16 is provided. The locking projection 16 is designed such that it has a bevelling 17 which, when the windlass handle is inserted in the corresponding cutout at the top of the windlass, by contact with the windlass will actuate the L-shaped locking member 10 to tilt/turn about the axis 14 against the force of the spring 15. Hereby, it is allowed that the first part 2 can be inserted in the windlass. When the first part has been inserted a certain length into the windlass, a groove at the bottom of the cutout of the windlass will enable the locking projection 16 to tilt due to the spring action on the L-shaped locking member 10, thereby retaining the windlass handle 1 in contact with the sheet windlass.

The handle 1 is then released by actuating the part of the L-shaped locking member 12 located over the spring 15 by compressing the spring such that the locking projection 16 will be withdrawn inside the cross-section of the first part 2, enabling the handle to be removed.

In an alternative embodiment (not shown), the arm 12 on the L-shaped member may largely lie in continuation of the arm 11 of the locking member. Manipulating the locking mechanism when releasing is then effected by actuating the arm 12 at a right angle to the axis of symmetry.

In order to improve easy handling, particularly by insertion of the windlass handle, the locking member is provided with a bevelling. In addition, the axis of rotation 14 may advantageously be disposed at a point above the bevelling, i.e. at a point on a line in parallel with the axis of symmetry 4 above the bevelling, e.g. opposite the joint with the torque transmitting part 3.

In the shown example, the L-shaped locking member 10 and in particular the release part 12 are shown as located in a hollow in the torque transmitting part 3 of the handle itself, however, obviously this part may be disposed above the geometry of the torque transmitting part 3. Furthermore, it will be possible to design the release mechanism as a pushbutton mechanism or in other ways.

1. A handle for a sheet windlass, where the handle is of the type having a first part adapted for engaging the windlass, a torque transmitting part arranged largely perpendicularly to an axis of symmetry of the first part and a grip arranged with its longitudinal axis in parallel with the axis of symmetry of the first part, where a releasable locking means is arranged in the first part, the locking means adapted to retain the handle in engagement with the sheet windlass, wherein the first part is a hole in a central part arranged coaxially with the axis of symmetry, and that an L-shaped locking member is provided in the hole, the locking member pivotably mounted in an upper part of the first part such that one leg of the L is arranged in the hole and the other leg of the L is arranged in parallel with the torque transmitting part, and that means are provided for urging the L-shaped locking member into a locking position where the end of the leg arranged in the hole in the first part has a projecting part extending beyond the geometry of the first part opposite the end of the first part where the torque transmitting part is fastened.

2. Handle according to claim 1, wherein the leg of the L arranged in parallel with the torque transmitting part is arranged in a cutout in the latter.

3. Handle according to claim 1, wherein the projecting part of the leg of the L arranged in the hole in the first part is provided with a bevelling such that when the first part is inserted in the windlass, the projecting part is pressed towards the centre against the means for urging the L-shaped locking member into the locking position.
